(19) United States
(12) Patent Application Publication
(10) Pub. No.: US 2011/0304426 A1
(43) Pub. Date: Dec. 15, 2011

(54) Security recognition system

(76) Inventor: Hung-Pin Liu, Taipei City (TW)

(21) Appl. No.: 12/815,839

(22) Filed: Jun. 15, 2010

(51) Int. Cl. G06F 7/04

(52) U.S. Cl. 340/5.53; 340/5.52

(57) ABSTRACT

A security recognition system comprises an electronic card, a card reading module, a biological feature capturing module and a comparison module. The electronic card has a biological feature storage module containing signature data. The card reading module reads a biological feature accessed by the electronic card. The biological feature capturing module captures the biological feature and transmits the feature to the comparison module for comparing. A rear bank mainframe or a credit card center connected to the security recognition module can determine whether a transaction is performed or a credit card is swiped according to the comparison result to enhance the security and anti-counterfeit for the electronic card.

### BACKGROUND OF THE INVENTION

1. Field of the Invention

The present invention relates to a security recognition system, and more particularly to a security recognition system capable of enhancing the security and anti-counterfeit of the electronic card.

2. Description of the Related Art

Since people make transaction behavior, merchandises with equivalent values are utilized to carry out the transaction between transaction parties. For example, barter in the early stage then evolved into metal currency (e.g., gold, silver, copper coins and so on) and further evolved into paper bills and checks. In the modern society, plastic or electronic monies (e.g., debit cards, credit cards, cash cards and so on) are frequently used. Accordingly, equivalent amount is used to achieve the transaction purpose in merchandise business. Before the plastic and electronic monies are not circulated, all transaction procedure for merchandises is carried out through currencies with equivalent values. If the amount or value is larger, unnecessary problems may easily take place. For instance, amount conversion may not be easily performed, cash changes may be inconvenient, and money may easily lose or be stolen. The appearance of plastic or electronic monies completely overcome the foregoing drawbacks and become a main stream for current merchandise transaction.

The foregoing plastic or electronic monies are frequently applied to business transactions. Similar technology is also widely utilized to various licensing certificates such as identification cards for accessing entrance guard controls, computer databases or confidential documents and pre-paid cards for use in transactions or transportations. No matter which type of electronic card is applied, it belongs to business transaction.

However, although currencies and paper bills can be replaced with electronic cards to carry out transactions, these cards are easily counterfeited, and the counterfeit cost is low as well. Those counterfeited cards are distributed in the market. According to statistics, credit card fraud in Taiwan may influence three hundred million U.S. dollars each year and needs to prevent the electronic cards from being counterfeited.

Some electronic cards are equipped with signatures to prevent counterfeit and help recognition. However, the recognition work is performed by manpower and easily causes human errors. In addition, some electronic cards adopt chips to prevent counterfeit. Nevertheless, many cards still utilize magnetic stripe cards that have worse security. Criminals may easily crack ciphers on magnetic stripes to achieve the purpose of stealing money. Accordingly, how to enhance the security of electronic cards is a primary objective and one of important issues to demand immediate attention.

### SUMMARY OF THE INVENTION

In view of the shortcomings of the prior art, the inventor of the present invention based on years of experience in the related industry to conduct extensive researches and experiments, and finally developed a security recognition system capable of enhancing the security and anti-counterfeit of electronic cards.

Therefore, it is a primary objective of the present invention to overcome the aforementioned shortcoming and deficiency of the prior art by providing a security recognition system.

To achieve the foregoing objective, the security recognition system of the present invention comprises an electronic card (e.g. a debit card or a credit card), a card reading module, a biological feature capturing module and a comparison module. The electronic card is equipped with a biological feature storage module containing signature data. The card reading module reads a biological feature accessed by the electronic card. The biological feature capturing module captures a biological feature and transmits the feature to the comparison module for comparison. A rear bank mainframe or a credit card center connected to the security recognition system can determine whether money is withdrawn or a credit card is swiped according to a comparison result to enhance the security and anti-counterfeit of electronic cards.

### BRIEF DESCRIPTION OF THE DRAWINGS

FIG. 1 is a block diagram of a security recognition system according to the present invention;

FIG. 2 is a structural diagram of a security recognition system according to a first embodiment of the present invention;

FIG. 3(A), (B) are schematic diagrams of a signature stroke according to the present invention; and

FIG. 4 is a structural diagram of a security recognition system according to a second embodiment of the present invention.

### DETAILED DESCRIPTION OF THE PREFERRED EMBODIMENTS

The foregoing and other technical characteristics of the present invention will become apparent with the detailed description of the preferred embodiments and the illustration of the related drawings.

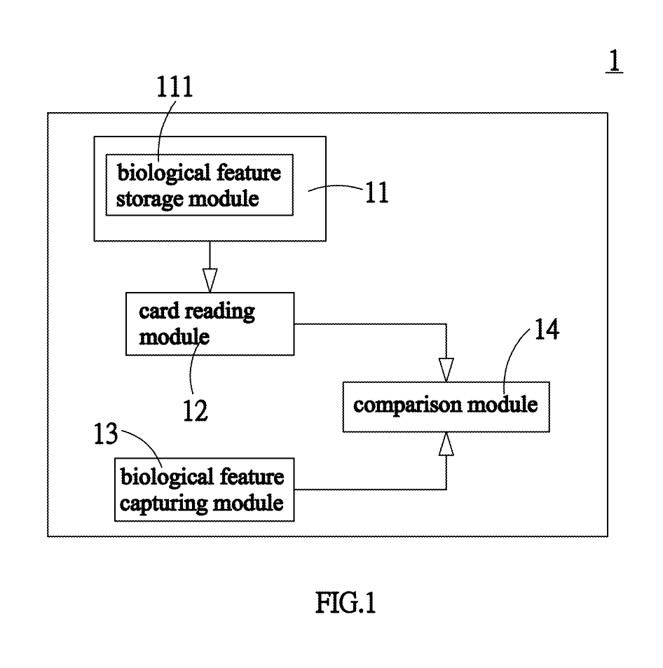

With reference to FIG. 1 for a security recognition system 1 comprises an electronic card 11 having a biological feature storage module 111 containing signature data; a card reading module 12 for reading a first biological feature accessed by the electronic card 11; a biological feature capturing module 13 for capturing a second biological feature; a comparison module 14, connected to the card reading module 12 and the biological feature capturing module 13, for receiving the first biological feature accessed by the electronic card 11 and the second biological feature accessed by the biological feature capturing module 13 and for comparing the first biological feature with the second biological feature to generate a comparison result.

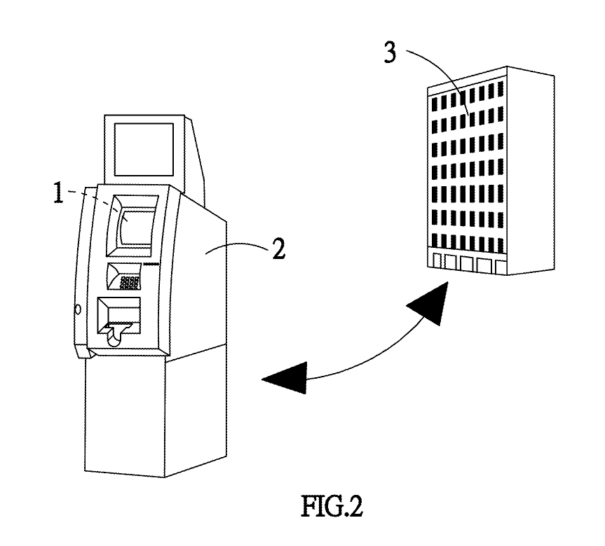

In a first embodiment of FIG. 1, the electronic card 11 can be a debit card. The card reading module 12, the biological feature capturing module 13 and the comparison module 14 are disposed in an automatic teller machine (ATM) 2. With reference to FIG. 2, the security recognition system 1 is further connected to a rear bank mainframe 3. When a user would like to use the electronic card to withdraw money from the ATM 2, the electronic card 11 is inserted into the ATM 2 in advance. The card reading module 12 in the ATM 2 firstly reads a specific biological feature (e.g., signature data) pre-accessed in the electronic card. The biological feature capturing module 13 can be a handwriting input board.

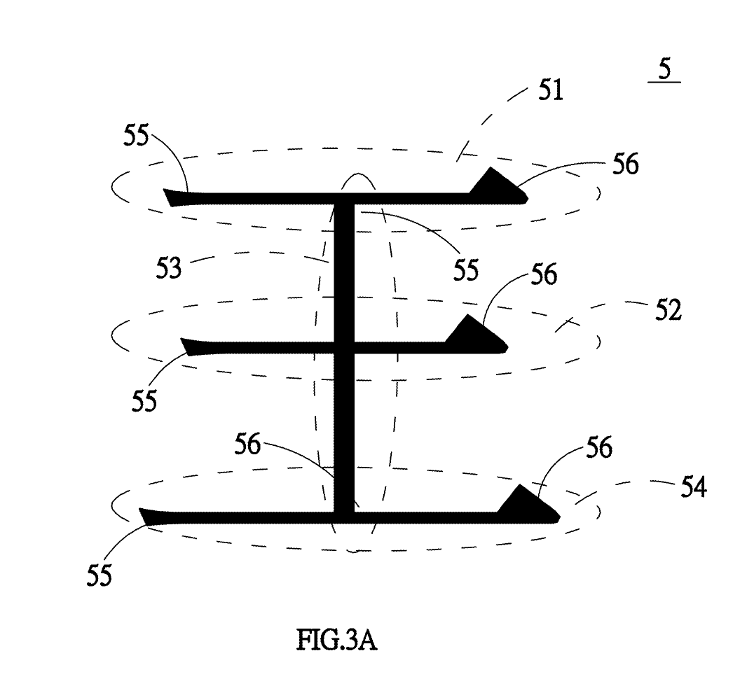

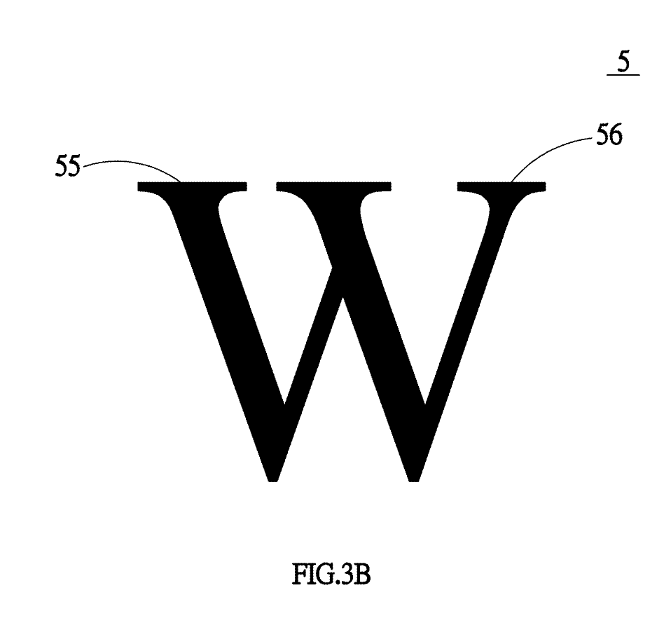

While in use, the user can manually input his/her signature data through the biological feature capturing module 13, and the biological feature capturing module 13 captures the signature data. The comparison module 14 then is used for comparison, and the comparison module 14 can comparing handwriting and pen-down of the signature, wherein the pen-down of the signature and magnitudes imposed by everyone are different. As shown in FIG. 3(A), the signature data comprises at least one character. For example, while writing a single character 5 of Chinese word “ [symbol] ” which is pronounced as Wang, the whole handwriting is compared in advance, and the pen-down then is compared. The character 5 comprises a plurality of strokes, wherein a first stroke 51 is heavier, a second stroke 52 is lighter, a third stroke 53 is heavier, and finally a fourth stroke 54 is lighter. The magnitudes between the strokes of the single character 5 of Chinese word “ [symbol] ” written by different people are slightly different. It does not only have the difference for the pen-down between the strokes, but also has the difference for the magnitudes between a starting end 55 and an ending point 56 of a single stroke. Certainly, the magnitude of pen-down of writing foreign languages is different as well. For example, while writing the single character 5 “W” as an English word, the single character 5 “W” is completed by a single stroke as shown in FIG. 3(B). Accordingly, the magnitudes of pen-down between the ending point 56 and the starting point 55 of the single stroke are compared to generate a comparison result. The comparison result then is transmitted to the rear bank mainframe 3. If the comparison result is matched (Namely the signature data manually inputted by a hand of the user is matched with the signature data presaved in the electronic card), the rear bank mainframe 3 performing the transaction (such as money withdrawing, account transfer, etc) based upon the result. If the comparison result is not matched (Namely the signature data manually inputted by a hand of the user is not matched with the signature data presaved in the electronic card), the rear bank mainframe 3 will not perform the transaction based upon the result.

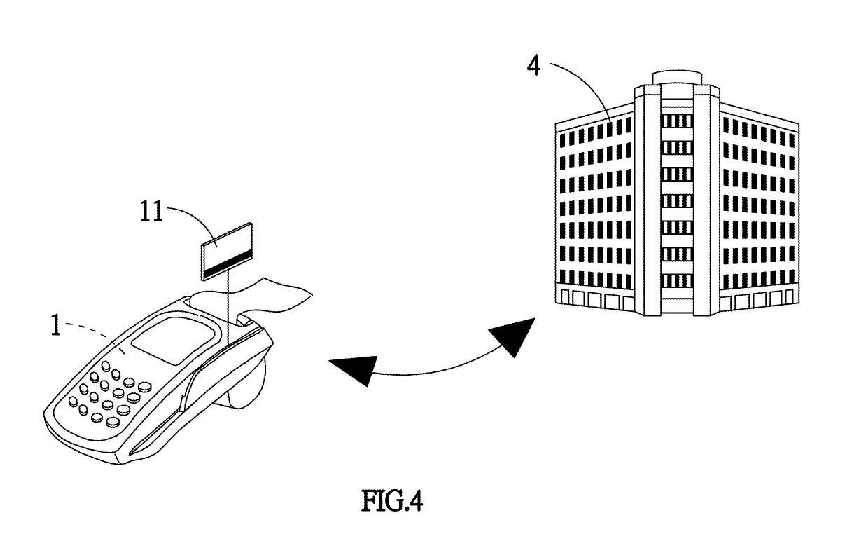

In a second embodiment of FIG. 4, the electronic card 11 can be a credit card. The security recognition system 1 is further connected to a credit card center 4. The credit card center 4 can receive the comparison result to determine whether or not the credit card is swiped.

Moreover, the biological feature can be a facial image. The biological feature capturing module can be a camera head for capturing an image of the biological feature. A facial feature of the user can be presaved in the electronic card. The comparison module is utilized to perform the comparison to obtain the comparison result after the camera head takes another facial image of the user.

The security recognition system of the present invention improves over the prior art and complies with patent application requirements, and thus is duly filed for patent application. While the invention has been described by device of specific embodiments, numerous modifications and variations could be made thereto by those generally skilled in the art without departing from the scope and spirit of the invention set forth in the claims.

What is claimed is:

1. A security recognition system comprising:
an electronic card having a biological feature storage module containing signature data;
a card reading module for reading a first biological feature accessed by the electronic card;
a biological feature capturing module for capturing a second biological feature; and
a comparison module, connected to the card reading module and the biological feature capturing module, for receiving the first biological feature accessed by the electronic card and the second biological feature captured by the biological feature capturing module and for comparing the first biological feature and the second biological feature to generate a comparison result.

2. The security recognition system as recited in claim 1, wherein the electronic card is a debit card, and the card reading module, the biological feature capturing module and the comparison module are disposed in an automatic teller machine (ATM), and the security recognition system is further connected to a rear bank mainframe, and the rear bank mainframe receives the comparison result to determine whether or not a transaction is performed.

3. The security recognition system as recited in claim 1, wherein the electronic card is a credit card, and the security recognition system is further connected to a credit card center, the credit card center receives the comparison result to determine whether or not the credit card is swiped.

4. The security recognition system as recited in claim 1, wherein the biological feature capturing module is a camera head for capturing an image of the second biological feature.

5. The security recognition system as recited in claim 4, wherein the second biological feature further comprises a facial image.

6. The security recognition system as recited in claim 1, wherein the biological feature capturing module is a handwriting input board for capturing the signature data.

7. The security recognition system as recited in claim 1, wherein the comparison module compares a pen-down with a handwriting shown in the signature data of the card reading module and the biological feature capturing module.

8. The security recognition system as recited in claim 7, wherein the signature data comprises at least one character having at least one stroke, and the comparison module compares magnitudes of a starting point and an ending point of a single stroke within the characters.

9. The security recognition system as recited in claim 7, wherein the signature data comprises at least one character having at least one stroke, and the comparison module compares magnitudes of pen-down between strokes within the characters.

10. A security recognition system comprising:
an electronic card having a biological feature storage module containing first signature data, the signature data comprising at least one character having at least one stroke;
a card reading module for reading the first signature data accessed by the electronic card;
a biological feature capturing module for capturing second signature data; and
a comparison module, connected to the card reading nodule and the biological feature capturing module, for receiving the first signature data accessed by the electronic card and the second signature data captured by the biological feature capturing module and for comparing magnitudes between handwritings and the strokes of the first signature data and the second signature data to generate a comparison result.

11. The security recognition system as recited in claim 10, wherein the comparison module compares the magnitudes between a starting point and an ending point of a single stroke within the characters.

12. The security recognition system as recited in claim 10, wherein the comparison module compares the magnitudes between the strokes of the characters.

13. The security recognition system as recited in claim 10, wherein the electronic card is a debit card, and the card reading module, the biological feature capturing module and the comparison module are disposed in an automatic teller machine (ATM), and the security recognition system is further connected to a rear bank mainframe, and the rear bank mainframe receives the comparison result to determine whether or not a transaction is performed.

14. The security recognition system as recited in claim 10, wherein the electronic card is a credit card, and the security recognition system is further connected to a credit card center, the credit card center receives the comparison result to determine whether or not the credit card is swiped.

15. The security recognition system as recited in claim 10, wherein the biological feature capturing module is a camera head for capturing an image of a biological feature.

16. The security recognition system as recited in claim 15, wherein the biological feature further comprises a facial image.

17. The security recognition system as recited in claim 10, wherein the biological feature capturing module is a handwriting input board for capturing the second signature data.
